(19) United States
(12) Patent Application Publication
(10) Pub. No.: US 2018/0050623 A1
(43) Pub. Date: Feb. 22, 2018

(54) Adjustable Transportation System for Transporting Using a Trailer

(71) Applicant: EZ PACK WATER LTD, Savion (IL)

(72) Inventors: Alex Harel, Savion (IL); Shalom Green, Haifa (IL); Ohad Zecharia, Kibutz Shomrat (IL)

(73) Assignee: EZ PACK WATER LTD, Savion (IL)

(21) Appl. No.: 15/562,418

(22) PCT Filed: Apr. 12, 2016
(86) PCT No.: PCT/IL2016/050381

§ 371 Date: Sep. 28, 2017

(30) Foreign Application Priority Data
Apr. 12, 2015 (IL) 238236

(51) Int. Cl. B60P 1/64

(52) U.S. Cl. CPC B60P 1/6445

(57) ABSTRACT

An adjustable transportation system designed to be positioned on a trailer or on a vehicle that includes a hammock-like structure, a frame, adjustable legs, and jacking means. The hammock-like structure is attached to the frame, as are the adjustable legs. The bottoms of said adjustable legs are equipped with jacking means.

### TECHNICAL FIELD

The present invention refers to an adjustable transportation system that includes a hammock-like structure, a frame, adjustable legs, and jacking means.

### BACKGROUND ART

There are many different cases and situations in which water tanks are required to be transported to open areas, for instance, when army forces are deployed in training or staging areas, or when the general public is participating in a large, outdoor event on. In such cases, it is currently customary to supply water using a water trailer that is towed by an appropriate vehicle. A standard water trailer consists of a water tank that is installed on a trailer. The vehicle tows the water trailer to the designated site, where it is detached from the vehicle, which later returns to picks it up when the event is over. The use of a standard water trailer entails several problems. First, the trailer itself, which is an integral part of the water trailer, must be left at the site for the entire time the water tank is required. Second, standard water trailers must be positioned on level and flat surfaces and cannot be used in non-level locations. The present invention addresses these two problems, as well as several others.

### DESCRIPTION OF THE DRAWINGS

The intention of the drawing attached to the application is not to limit the scope of the invention and its application. The drawing is intended only to illustrate the invention and it constitutes only one of its many possible implementations.

FIGS. 1 and 2 depict the adjustable transportation system (1), which comprises a hammock-like structure (2), a frame (3), adjustable legs (4), and jacking means (5).

FIG. 3 depicts the hammock-like structure (2), wherein it is installed on a trailer (200) and is carrying a flexible water tank (100).

FIG. 4 depicts the adjustable transportation system (1), wherein the hammock-like structure (2) is installed on a trailer (200) and wherein the frame (3) and the adjustable legs (4) are assembled and attached.

FIG. 5 depicts the adjustable transportation system (1) after it has been raise slightly above the trailer (200) and the trailer has started to move out from under the system (1).

FIG. 6 depicts the adjustable transportation system (1) after the trailer (200) has entirely moved out from under it.

### THE INVENTION

The main objective of the present invention is to provide an adjustable transportation system (1) that comprises a hammock-type structure (2), a frame (3), adjustable legs (4), and jacking means (5). The adjustable transportation system (1) is designed so that it may be positioned on a trailer or on the open cargo area of a pickup truck and by transported by a vehicle to the designated site. A water tank may be installed on the hammock-like structure (2), and it is obviously recommended that a flexible water tank be used since flexible water tanks offer several advantages over fixed-volume water tanks. When a need arises to supply water to an outdoor location, and the user wishes to transport a water tank, the adjustable transportation system (1) can be installed on a trailer, and a water tank can be placed on the hammock-like structure (2) and transported to the designated site. Upon arriving at the site, the user assembles the frame (3) and connects it to the hammock-like structure (2). Then, the adjustable legs (4) are assembled and connected the frame (3), and the system (1) is raised using the jacking means (5), so that the trailer may be moved out from under the system (1), leaving the system in place with the water tank on its hammock-like structure (2). The vehicle and the trailer may now be driven away to be used for other tasks.

The expression “flexible water tanks” refers to inflatable tanks that were developed in order to maximize their storage and transportation efficiency. Flexible water tanks are made of a heavy-duty exterior layer, made of a material such as PVC, and an internal layer that complies with standards for the storage of drinking water. Flexible water tanks are typically equipped with a spigot through which the tank is filled and through which water is consumed.

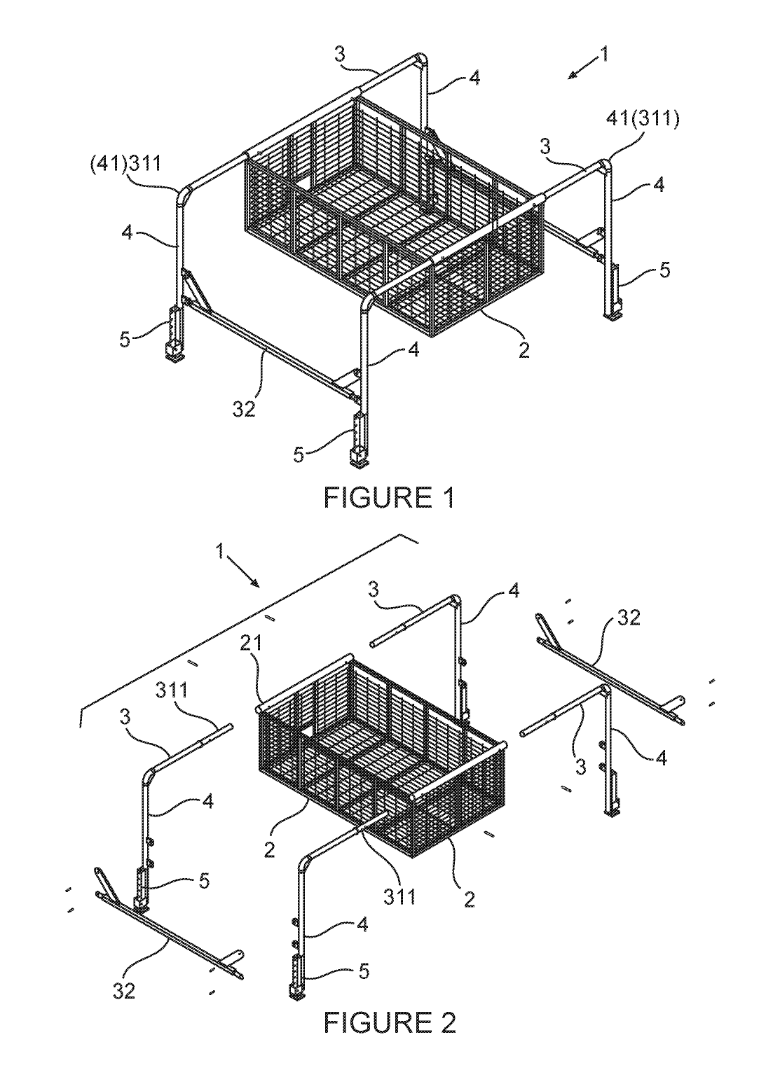

As mentioned, the adjustable transportation system comprises a hammock-like structure (2), a frame (3), adjustable legs (4), and jacking means (5). FIGS. 1 and 2 depict the adjustable transportation system (1), which comprises a hammock-like structure (2), a frame (3), adjustable legs (4), and a jacking means (5).

The hammock-like structure (2) is in fact a platform on which the water tank (100) is placed, and it may be flat or have side walls that prevent the water tank from falling off during transportation. The drawings accompanying this patent application depict a hammock-like structure (2) with a platform comprising a lattice bottom and side walls, although the invention refers to other designs as well. The hammock-like structure (2) is equipped with several connecting devices (21) that are intended to enable the user to attach the hammock-like structure (2) to the frame (3).

The frame (3) is designed so as to enable the user to assemble and connect the adjustable legs (4) to the hammock-like structure (2). The frame comprises several horizontal rods (31), each of which is equipped with connecting means (311) at either end. The frame should have four horizontal rods (31), or more, to enable at least one horizontal rod (31) to be attached to each corner of the hammock-like structure (3). The frame (3) may also include a bottom frame (32) that interconnects the legs (4) and thus reinforces and stabilizes the system (1).

Adjustable legs (4): The adjustable transportation system (1) is equipped with several adjustable legs (4) and, obviously, it is desirable that the system (1) have at least four such legs. The adjustable legs (4) are adjustable in the sense that the user may change their height in order to raise the hammock-like structure (2) above the trailer or vehicle, thus “releasing” the trailer or vehicle while the system (1) is positioned in a stable manner on the ground. The adjustable legs (4) also enable the system (1) to be used on non-level or uneven surfaces. Some or all of the adjustable legs (4) can be telescopic or can incorporate jacking means (5), which are usually located at the lower end of the leg. The upper end of the adjustable legs (4) is attached to the frame (3) by means of the connecting means (41) located at the upper end of each leg (4), which connects to a corresponding fastening means (311) located at the end of the horizontal frame rod (31).

The jacking means (5) is designed to enable the user to shorten or lengthen the adjustable leg (4) so as to level the hammock-like structure (2). The jacking means (5) can be operated manually, like a vehicle's jack, electrically, or pneumatically, wherein electricity and air pressure are provided by the towing vehicle or any other source. The user can raise the adjustable legs (4) using the jacking means (5) in order to stabilize the adjustable transportation system (1) on the designated site. The adjustable legs (4) can be permanently connected or they may be detachable, in which case the user attaches them to the frame (3) and detaches them according to need.

It is very important that the hammock-like structure (2), on which the flexible water tank is placed, be horizontal and level and that it is at an angle when positioned at the designated site. If the flexible water tank is positioned at an angle, the water within the tank will apply both a horizontal force and a downward force at an angle, towards the lower side of the tank, which can cause the system to become instable, and to collapse, tilt, or overturn. Hence the importance of the adjustable legs (4) and jacking means (5), as mentioned above, which are designed enable the use to level the hammock-like structure (2) on which the water tank is placed. The adjustable transportation system (1) can be used to transport not only water tanks, but any other equipment as well, according to need.

The connecting means (21), (311) and (41) of the hammock-like structure (2), the frame (3), and the legs (4), respectively, can be of a variety of types. For instance, the ends of the rods (31) and the legs (4) can serve themselves as connecting means, wherein one rod is inserted into another rod. It is also possible that said connecting means be composed of a hollow rod into which another rod is inserted, with a locking means, and so on.

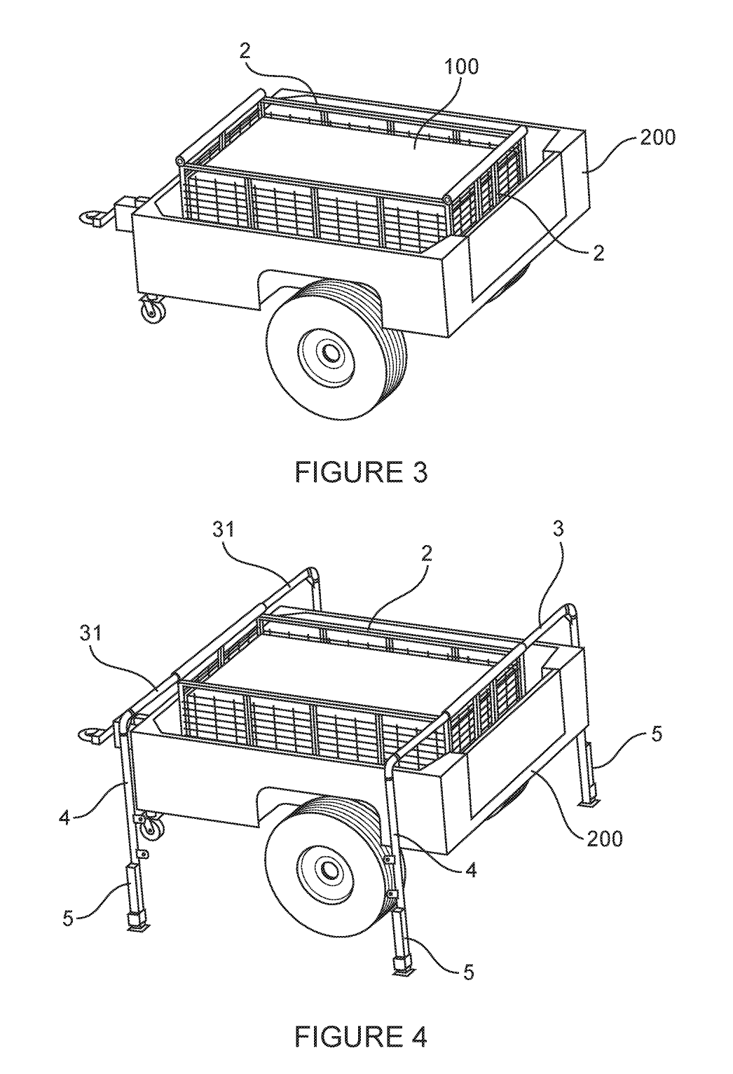

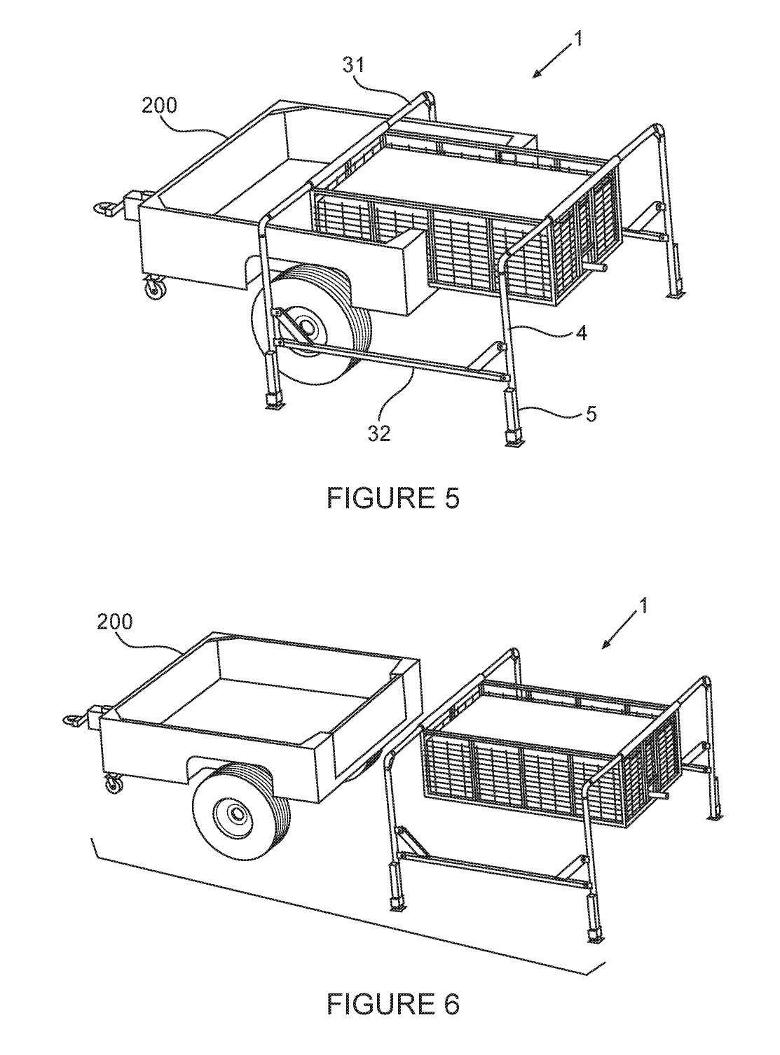

FIG. 3 depicts the hammock-like structure (2), wherein it is installed on a trailer (200) and is carrying a flexible water tank (100). FIG. 4 depicts the adjustable transportation system (1), wherein the hammock-like structure (2) is installed on a trailer (200) and wherein the frame (3) and the adjustable legs (4) are assembled and attached. FIG. 5 depicts the adjustable transportation system (1) after it has been raised slightly above the trailer (200) and the trailer has started to move out from under the system (1). FIG. 6 depicts the adjustable transportation system (1) after the trailer (200) has entirely moved out from under it.

What is claimed is:

1. An adjustable transportation system designed to be positioned on a trailer or on a vehicle that includes a hammock-like structure, a frame, adjustable legs, and jacking means; wherein the hammock-like structure is attached to the frame; wherein the adjustable legs are also attached to the frame; wherein the bottoms of all or some of said adjustable legs are equipped with jacking means.
